(19) United States
(12) Patent Application Publication
(10) Pub. No.: US 2006/0042134 A1
(43) Pub. Date: Mar. 2, 2006

(54) Apparatus and method for retail display of cosmetic and other products

(76) Inventors: Reginald Lyon, Colleyville, TX (US); Renee Griffin, Ft. Lauderdale, FL (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 11/182,496

(22) Filed: Jul. 15, 2005

Related U.S. Application Data
(60) Provisional application No. 60/588,258, filed on Jul. 15, 2004.

(51) Int. Cl. G09F 1/00

(52) U.S. Cl. 40/124.01

(57) ABSTRACT

The present invention is directed towards an improved apparatus and method for providing improved cosmetic display apparatuses. In one embodiment, a plurality of peel-away plastic guards is provided to protect the text headers and graphics on an exposed surface that may become tainted with “test” markings of cosmetics. As the outer layer becomes dirty or stained with cosmetics, the outer layer can be peeled away, removed, and disposed. This provides a “fresh” surface that is aesthetically superior to one that has been stained with various colors of cosmetics. The strips are compiled into an assembly comprised of four layers, although other numbers of layers may be provided without departing from the spirit and scope of the present invention.

### CROSS REFERENCE SECTION

This application claims the benefit and priority of U.S. Provisional Application No. 60/588,258, filed Jul. 15, 2004, which is incorporated herein in its entirety.

### FIELD OF THE INVENTION

The present invention generally relates to display apparatuses. More particularly, to display apparatuses for cosmetic products.

### BACKGROUND OF THE INVENTION

It is commonly known to provide locations for retail sales of cosmetic products such as lipstick, nail polish, and eyeliner. When considering the purchases of such products at such retail locations, many times the prospective customers will “test” the product by opening the product and applying it to some convenient surface in order to visually review and/or compare the coloring, texture, or other properties of the cosmetic product. Often this convenient surface is the nearest flat surface. Typically, the nearest flat surface is a graphic display of some kind, such as a product or store advertisement. These displays are often found on the front of a fixture holding a plurality of cosmetic items, or on a graphic such as used on the front of a tray. The tray typically holds several cosmetic items such as a variety of nail polish colors and the “front” is similar to the front face of a drawer.

Often, a customer will apply a test mark on the display or graphic for a variety of items prior to selecting a specific item for purchase. This process results in unsightly markings or stains on what would otherwise be advantageously aesthetic displays meant for marketing and/or identifying the product. This is especially true after several customers have applied test marks.

Therefore, a need exists for apparatuses and methods of use that reduce the effects of test stains provided on flat-surfaces such as cosmetic fixture displays or storage tray fronts.

### BRIEF SUMMARY OF THE INVENTION

Embodiments of the present invention provide improvements over the prior art by providing a removable plastic strip or film that is applied to a display or graphic to protect it from “testing” marks from cosmetic products. After the strip becomes tainted by cosmetics or other products, it may be removed to refresh the aesthetics of the display or graphic.

In one aspect of the present invention, an apparatus for displaying information is provided. The apparatus includes a cosmetic display configured to position text, graphics or both for viewing by a prospective customer, and a substantially transparent plastic strip configured to be removeably attached to the cosmetic display such that the text, graphic or both can be viewed through the plastic strip.

In a further aspect of the present invention, an apparatus for displaying information is provided. The apparatus includes a cosmetic display configured to position text, graphics or both for viewing by a prospective customer, and a plurality of substantially transparent plastic strips arranged in layers to form a stack assembly. This stack assembly includes a first layer configured to be removeably attached to the cosmetic display such that the text, graphics or both can be viewed through the stack assembly, and a second layer configured to be removed from the stack assembly without removing the first layer from the cosmetic display.

In another aspect of the present invention, a method for refreshing the aesthetics of a cosmetic display is provided. The method includes the steps of providing a cosmetic display configured to present text, graphics or both, removeably attaching a stack assembly comprising a plurality of plastic strips configured in layers to the cosmetic display such that the text, graphics or both can be viewed through said plurality of plastic strips, and peeling away the outer most layer of said stack assembly to reveal a superior display aesthetic.

Other objects, features, and advantages of the present invention will become apparent upon reading the following detailed description of the preferred embodiment of the invention when taken in conjunction with the drawing and the appended claims.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an illustrative view showing an exemplary fixture display 10.

FIG. 2 is an illustrative view showing a plastic strip 20 used in connection with a fixture display 10 in accordance with an embodiment of the present invention.

FIG. 3 is an illustrative view showing a plastic strip 20 in accordance with an embodiment of the present invention.

FIG. 4 is an illustrative view showing a stack assembly 30 including multiple plastic strips in accordance with an embodiment of the present invention.

FIG. 5 is an illustrative view of a stack assembly 30 in accordance with an embodiment of the present invention.

FIG. 6 is an illustrative view showing an exemplary storage tray 50.

FIG. 7 is an illustrative view showing a plastic strip 55 used in connection with a tray front in accordance with an embodiment of the present invention.

FIG. 8 is an illustrative view showing a stack assembly 60 used in connection with a tray front in accordance with an embodiment of the present invention.

### DETAILED DESCRIPTION OF THE INVENTION

The present inventions will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### General Description of the Invention

Generally described, embodiments of the present invention provide one or more transparent film or plastic strips that are removeably attached to a cosmetic display to shield it from prospective customers “test” cosmetic marks. The plastic strips protect the underlying cosmetic display from the unsightly cosmetic test marks and can be peeled away and discarded when desired. In one embodiment, a stack assembly that has multiple plastic strip layers is removeably attached to a cosmetic display such that the outer most layer may be removed periodically as it becomes tainted with test marks and the remaining layers continue to protect the underlying cosmetic display. In other embodiments, a single plastic strip is removeably attached to the cosmetic display.

As the outer layer becomes dirty or stained with cosmetics, it can be peeled away, removed, and disposed of. The outer layer may be removed periodically or appearance standards may be established for determining when the outer layer is to be removed. For example, the standard could establish a threshold for the number of marks on the display, the percentage of the display that is obscured by the test marks or identify critical information that must not be obscured by cosmetic marks such as the price or manufacturer's logo. Typically the outer most layer will be peeled off by a retail store employee, although it is contemplated that consumers could also remove the strips if suitably instructed.

### Fixture Guard Embodiments

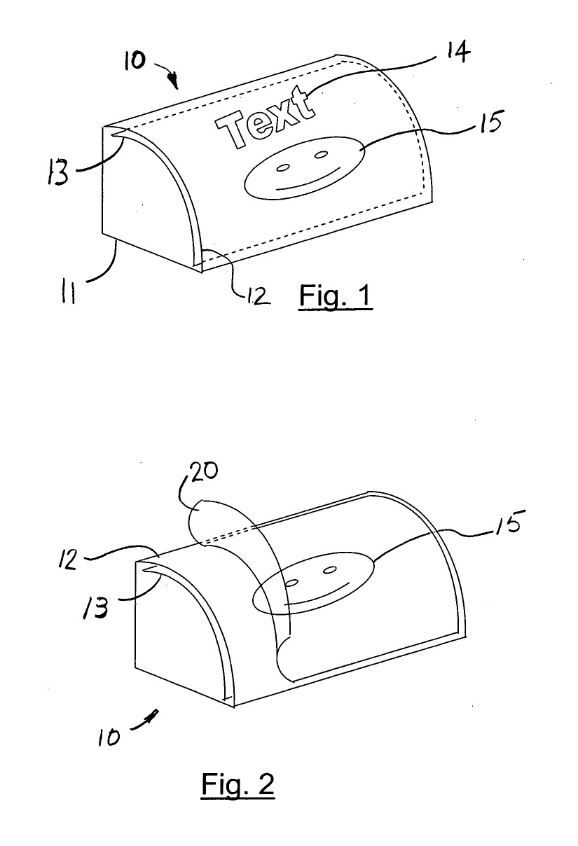

The fixture guard embodiments of the present invention shield the cosmetic fixture display from prospective customers testing the properties of cosmetic products. FIG. 1 illustrates an exemplary fixture display 10 used in the retail cosmetic industry. This display is typically constructed of transparent material such as plastic and provides a means for displaying information such as text headers and graphics to identify and market cosmetic products. The fixture display 10 includes an “L” shaped base portion 11 with an arcuate portion 12 extending between the legs of the base portion 11. A suitably sized placard or poster 13 having text headers 14 and graphics 15 printed thereon is positioned adjacent the interior surface of the arcuate portion 12 of the fixture display 10 such that the text headers 14 and graphics 15 can be viewed through the substantially transparent arcuate portion 12 of the fixture display 10. This configuration allows the retail location to easily replace the poster 13 with different text headers 14, graphics 15 or both due to the introduction new products or new marketing campaigns.

When installed at a retail location, the exterior surface of the arcuate portion 12 of the fixture display 10 is exposed to the public and is often used by consumers to test the color, texture or other properties of cosmetic products such as lipsticks, nail polish, eyeliner and the like.

In FIG. 2, an embodiment of the present invention is shown in connection with a fixture display 10. In this embodiment, a single protective plastic strip 20 is removably attached to the exterior surface of the arcuate portion 12 of the fixture display 10 to shield it from prospective customer's test marks. In addition to protecting against cosmetic test marks, the plastic strip may also provide some protection from other unsightly marks such as smudges, fingerprints, pen or pencil marks, and the like. Because the plastic strips are removeably attached to the fixture display, they can be peeled away from the fixture display and disposed of when it becomes tainted with marks. The text headers and graphics remain when the plastic strip 20 is removed and a new, unmarked plastic strip can then be applied to the fixture display. Although FIG. 2 only shows a graphic 15, it should be understood that the poster 13 held by the fixture display 10 may include text, a graphic or both.

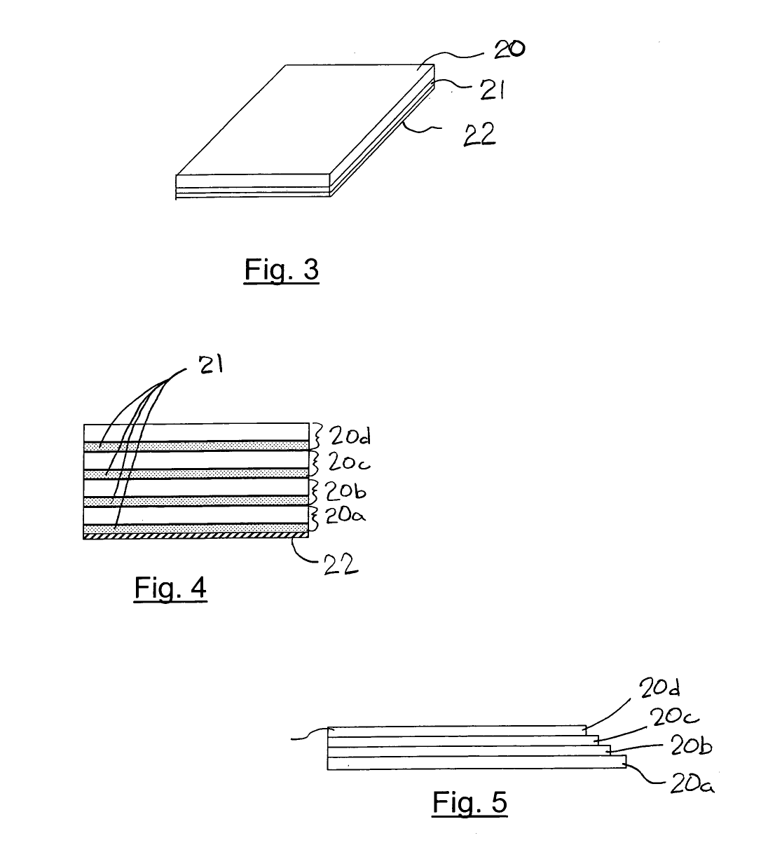

FIG. 3 illustrates a plastic strip 20 in accordance with an embodiment of the present invention. The plastic strip 20 is substantially transparent and is preferably formed from polyurethane. But, as will be understood by those of skill in the art, the plastic strip 20 may be formed from any plastic material such as for example polyolefin, polyester or polyvinyl chloride.

To removeably attach the plastic strip 20 to the fixture display, an adhesive 21 is applied to one side of the plastic strip 20. In one embodiment, the adhesive 21 is a pressure sensitive adhesive; however, any type of adhesive may be used without departing from the spirit and scope of the present invention. A backing layer 22 is preferably applied to the adhesive side of the plastic strip 20 to reduce the opportunity for foreign material such as dirt or lint to attach to the plastic strip prior to use. This backing layer 22 is removed and discarded just prior to removeably affixing the plastic strip 20 to the fixture display 10.

To enhance the appearance of the underlying text headers and graphics, the plastic strip 20 may be textured. In further embodiments, the plastic strip is tinted or contains a pre-printed graphic thereon to complement the underlying text headers and graphics. An example of a graphic would be a trademark or logo for the cosmetic manufacturer.

In one embodiment of the present invention, the plastic strips 20 are sized to substantially cover the fixture display. Alternatively, the plastic strips 20 could be supplied in a roll or in standard sizes and cut to fit by the cosmetic retailer. Although the plastic strips 20 shown in FIGS. 2-3 are substantially rectangular, it should be understood that the plastic strips may be cut to any shape without departing from the spirit and scope of the present invention.

Turning to FIG. 4, an additional embodiment of the present invention provides an stack assembly 30 which includes a plurality of plastic strips 20a-d arranged in layers. This stack assembly 30 is removeably attached to the fixture display 10 such that the text headers and graphics can be viewed there through. Each plastic strip 20a-d includes an adhesive applied to one side which provides a means for removeably attaching the layers together and for removeably attaching the bottom layer 20a to the fixture display 10. As with the single strip embodiments, the plastic strips 20a-d in the layered embodiments may include texturing, tinting or pre-printed graphics. To facilitate peeling away of individual layers, tabs may be provided on the strips or the lengths of the individual strips may be staggered as generally shown in FIG. 5 such that a user can readily distinguish between the different layers.

In use, the stack assembly 30 is removeably affixed to the accurate portion 12 of the fixture display 10. When the outer most layer (10d in the illustrated embodiment) becomes tainted with cosmetics, it can be peeled away, removed, and disposed of. This provides a “fresh” surface that is aesthetically superior to one that has been stained with various colors of cosmetics. The text headers and graphics are not removed and the remaining layers continue to shield the fixture display from cosmetic marks.

In FIG. 4, the plastic strips are compiled into a stack assembly comprised of four layers, however other numbers of layers may be provided without departing from the spirit and scope of the present invention.

As with the single plastic strip embodiments, the removable strips 10a-d may be formed from any plastic material such as for example polyurethane, polyolefin, polyester or polyvinyl chloride.

### Graphic Shield Embodiments

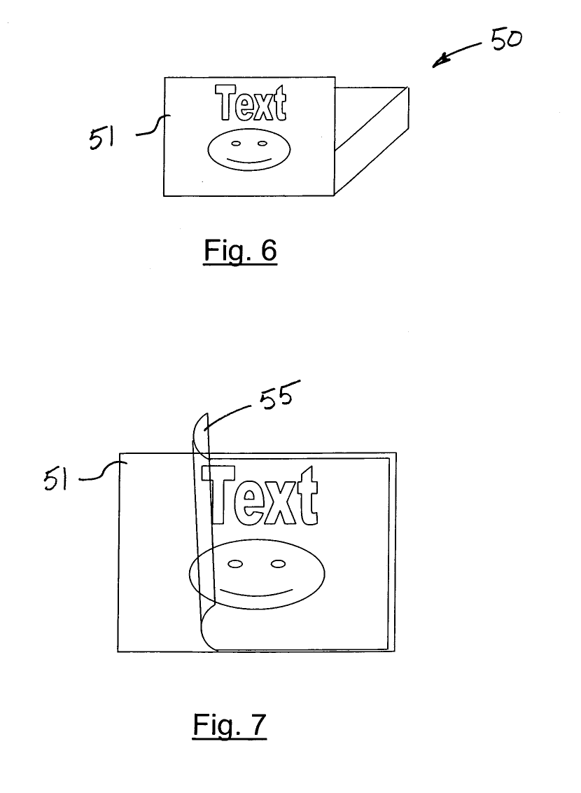

The graphic shield embodiments of the present invention shield storage tray fronts from cosmetic marks made by prospective customer testing various properties of cosmetic products. FIG. 6 illustrates an exemplary storage tray 50. Generally described, the tray 50 stores various cosmetic items such as lipstick, nail polish, eyeliner and includes a front 51 which is configured to display information about the cosmetics such as text headers and department graphics. These types of trays are commonly used in cosmetic displays. Because of the proximity of the tray front 51 to the various cosmetic items, it is often used as a surface to test the texture, color or other properties of the cosmetic items by prospective customers.

In one embodiment of the present invention shown in FIG. 7, a single protective plastic strip 55 is removably attached to the exterior surface of a tray front 51 to shield it from cosmetic marks. In addition to protecting against cosmetic marks, the plastic strip 55 may also provide some protection from other unsightly marks such as smudges, pen or pencil marks, and the like. Because the plastic strip 55 is removeably attached to the tray front, it can be peeled away from the tray front 51 and disposed of when it becomes tainted with marks. The text headers and graphics remain when the plastic strip 55 is removed and a new, unmarked plastic strip 55 can then be applied to the tray front 51.

The plastic strip 55 is substantially transparent such that the text headers and graphics can be viewed there through. To removeably attach the plastic strip to the tray front, an adhesive is applied to one side of the plastic strip 55. In one embodiment, the adhesive is a pressure sensitive adhesive; however, any type of adhesive may be used in connection with the present invention without departing from the spirit and scope of the present invention. A backing layer is preferably applied to the adhesive side of the plastic strip to reduce the opportunity for foreign material such as dirt or lint to attach to the plastic strip prior to use. This backing layer would be removed and discarded just prior to removeably affixing the plastic strip to the tray front.

As with the fixture guard embodiments, the plastic strips 55 may be formed from any type of plastic and may be sized to substantially cover a tray front of any shape. Furthermore, the plastic strip 55 may be tinted, textured and/or include a graphic.

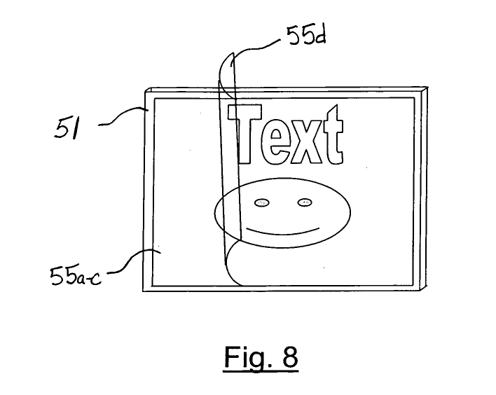

In a further embodiment shown in FIG. 8, a stack assembly 60 is provided that includes a plurality of plastic strips 55a-d arranged into layers in the same manner as shown for layers 20a-d of apparatus 30 in FIG. 4 to form a stack assembly of plastic strips. The apparatus 60 is removeably attached to a tray front similar to the manner in which the apparatus 30 is affixed to the fixture display as generally described above. Each plastic strip includes an adhesive applied to one side. As with the single strip embodiments, the plastic strips 55a-d in the layered embodiments may include texturing, tinting or pre-printed graphics. Similar to the fixture guard embodiments, the individual layers may be configured with tabs or the lengths of the individual strips may be staggered such that a user can readily peel away the outer most layer as desired.

In use, the stack assembly 60 is removeably attached to the tray front 50. As the outer most layer 55d becomes dirty or stained with cosmetics, it can be peeled away as illustrated in FIG. 8 and disposed of. This provides a “fresh” surface that is aesthetically superior to one that has been stained with various colors of cosmetics. The underlying layers (55a-c) of the stack assembly 60 remain on the tray front as well as the text and graphics. It should be understood that any number of layers may be used in connection with the graphic shield embodiments of the present invention without departing from the spirit and scope of the present invention.

### Alternatives and Options

It may be understood that many modifications and other embodiments of the inventions set forth herein will come to mind to one skilled in the art to which these inventions pertain having the benefit of the teachings presented in the foregoing descriptions and the associated drawings. One modification includes the provision of a “logo” or other such indicia pre-printed on the removable strips, such as the logo of a cosmetic manufacturer.

In a further alternative, a plastic sheet may be permanently affixed to the fixture display, tray front or graphic to protect it from cosmetic marks in order to. In which case, the cosmetic marks would be cleaned from the permanently affixed plastic strip to remove the marks and improve the aesthetics of the display or graphic.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus for displaying information, said apparatus comprising:
a cosmetic display configured to position text, graphics or both for viewing by a prospective customer; and
a substantially transparent plastic strip configured to be removeably attached to said cosmetic display such that said text, graphic or both is viewed through said plastic strip.

2. The apparatus of claim 1 wherein said cosmetic display is a fixture display.

3. The system of claim 1, wherein said cosmetic display is a cosmetic tray front.

4. The system of claim 1, wherein said removable plastic strips include a pre-printed logo thereon.

5. The system of claim 4, wherein said pre-printed logo is that of a cosmetics manufacturer.

6. An apparatus for displaying information said apparatus comprising:
a cosmetic display configured to position text, graphics or both for viewing by a prospective customer; and
a plurality of substantially transparent plastic strips arranged in layers to form a stack assembly of said plastic strips comprising:
a first layer configured to be removeably attached to said cosmetic display such that said text, graphics or both is viewed through said stack assembly; and
a second layer configured to be removed from said stack assembly without removing said first layer from said cosmetic display.

7. The apparatus of claim 6 further comprising a third layer intermediate said first layer and said second layer wherein said third layer is removeably attached to said first layer and said second layer is removeably attached to said third layer to form said stack assembly, wherein further said third layer is configured to remain removeably attached to said first layer when said second layer is removed.

8. The apparatus of claim 6, wherein said cosmetic display is a fixture display.

9. The system of claim 6, wherein said cosmetic display is a cosmetic tray front.

10. The system of claim 6, wherein said removable plastic strips include a pre-printed logo thereon.

11. The system of claim 10, wherein said pre-printed logo is that of a cosmetics manufacturer.

12. A method for refreshing the aesthetics of a cosmetic display, said method comprising the steps of:
providing a cosmetic display configured to present text, graphics or both;
removeably attaching a stack assembly comprising a plurality of plastic strips configured in layers, to said cosmetic display such that said text, graphics or both can be viewed through said plurality of plastic strips; and
peeling away the outer most layer of said stack assembly to reveal a superior display aesthetic.

13. The method of claim 12, wherein the outer most layer of said plurality of plastic strips is removed at periodic time intervals.

14. The method of claim 12, wherein the outer most layer of said plurality of plastic strips is removed based at least in part on a predetermined standard.

15. The method of claim 12, wherein the outer most layer of said plurality of plastic strips is removed by a prospective customer.
